(19) United States
(12) Patent Application Publication
(10) Pub. No.: US 2022/0402185 A1
(43) Pub. Date: Dec. 22, 2022

(54) METHOD AND COMPUTER PROGRAM PRODUCT FOR IMPROVING A CYCLE TIME

(71) Applicant: ENGEL AUSTRIA GmbH, Schwertberg (AT)

(72) Inventors: Anton LOHNECKER, Ertl (AT); Herbert ZEIDLHOFER, Haag (AT)

(21) Appl. No.: 17/839,880

(22) Filed: Jun. 14, 2022

(30) Foreign Application Priority Data
Jun. 16, 2021 (AT) A 50483/2021

(51) Int. Cl. B29C 45/76; G05B 19/418

(52) U.S. Cl. CPC B29C 45/768; B29C 45/762; G05B 19/41875

(57) ABSTRACT

Method for improving a cycle time of a molding system operating in cycles, wherein the molding system is set up to produce molded parts in cycles, wherein the cycles include partial phases, for at least one partial phase or at least one group of partial phases a partial phase duration is measured or ascertained with reference to settings of the molding system, an optimum partial phase duration is calculated for the at least one partial phase or the at least one group of partial phases on the basis of a machine configuration, if the measured or ascertained partial phase duration deviates from the optimum partial phase duration by more than a predefined amount, an indication that the setting of the molding system is improvable with respect to the at least one partial phase or the at least one group of partial phases is issued.

The present invention relates to a method and a computer program product for improving a cycle time of a molding system operating in cycles.

Various possibilities for optimizing individual partial phases of the cycles in terms of time are known, for which reference is to be made for example to AT 519253 A4, AT 522075 A4, AT 513654 A2 or AT 502382 A4.

In the case of molding systems operating cyclically (which include e.g. injection-molding machines, transfer-molding machines, molding presses or the like), an important factor for economic efficiency, besides the process reliability and the reproducible quality of the parts, is the production time per unit produced. This production time per unit produced is generally referred to as cycle time in the case of molding systems operating in cycles.

With respect to improving the quality of the parts or reproducibility, there are, especially in injection molding, a large number of support programs and patents which are intended to help the operator/user of such machines to produce an optimum product, regarding which reference is to be made for example to DE 10247565 A1, DE 69936385 T2 or EP 0573912 A1.

This is also understandable insofar as a high-quality molded part is even the prerequisite for being able to operate the molding system efficiently. On the other hand, with respect to cycle time optimization there is only very little and/or no integrated support. This is because, for one thing, it is often assumed that the machine operator is as focused on the optimization of the cycle time as on the process optimization and, for another, the general consensus is that it is obvious and a simple matter to set the shortest possible cycle time.

However, experience shows that operators of molding systems are usually not at all aware of how large the savings potential is with respect to the cycle time. In the case of the quality of the parts, for example, it can clearly be assessed whether or not a molded part conforms to the required quality. However, whether the optimum has been achieved in the case or the cycle time can only be assessed with great difficulty, as very often a large number of individual times or possibilities for time savings come into play here. These individual contributions to improving the cycle time often only vary in the range of tenths or hundredths of a second.

Although most machine manufacturers provide a graph or another form of presentation of the cycle times and the individual movements, the large number of possible small contributions to improving the cycle time can usually be recognized thereon only with difficulty.

The object of the invention is therefore to provide a method, a computer program product and a molding system, whereby improved cycle times can be achieved in practice.

With respect to the method, this is achieved by the features of claim 1, namely in that
the molding system is set up to produce molded parts in cycles, wherein the cycles include partial phases,
for at least one partial phase or at least one group of partial phases a partial phase duration is measured or ascertained with reference to settings of the molding system,
an optimum partial phase duration is calculated for the at least one partial phase or the at least one group of partial phases on the basis of a machine configuration,
if the measured or ascertained partial phase duration deviates from the optimum partial phase duration by more than a predefined amount, an indication that the setting of the molding system is improvable with respect to the at least one partial phase or the at least one group of partial phases is issued.

With respect to the computer program product, the object is achieved by the features of claim 8, namely by instructions which prompt a computer executing them
to receive data in the form of measured values and/or setting data and to determine a partial phase duration for at least one partial phase of the cycles or at least one group of partial phases of the cycles with reference to the measured values or setting data,
to calculate an optimum partial phase duration for the at least one partial phase or the at least one group of partial phases on the basis of a machine configuration and
to check whether the measured or ascertained partial phase duration deviates from the optimum partial phase duration by more than a predefined amount and, if this is the case, to issue an indication that the setting of the molding system is improvable with respect to the at least one partial phase or the at least one group of partial phases.

As the achievement of a stable and reliable molding process is usually prioritized when the molding process is set up to produce molded parts, as mentioned, settings which are not optimal for the cycle time often arise. Through the invention, operators or the molding system are actively advised that the cycle time can at least potentially be improved.

It can particularly preferably be provided that a machine control system of the molding system automatically carries out the method according to the invention.

As already mentioned, the period in which the molding system produces a unit is referred to as cycle and the length of this period is referred to as cycle time. However, it should be mentioned that the unit produced need not necessarily be precisely one molded part. For example in the case of injection molds, there can be several mold cavities, which allow several molded parts to be molded at the same time. In this case, the “unit produced” would be all of the molded parts that can be produced in one time sequence.

The partial phases of the cycle normally differ due to differing movements of components of the molding system or the molding machine used (example: open mold or close mold). However, periods in which only a temperature control is carried out can also be categorized as partial phases of the cycle (example: cooling time for an injection-molded part). It is likewise conceivable that several movements or periods are combined into one partial phase if this seems sensible in the specific situation, for example because certain movements are always carried out together and as a result do not require optimization.

It should be mentioned that the partial phases do not necessarily have to run strictly sequentially. In many cases, movements in a molding system take place at the same time or at least with a certain time overlap.

Within the framework of the invention, both individual partial phases and groups of partial phases can then be checked for whether they deviate from the optimum partial phase duration by more than a predefined amount. It should be mentioned that the partial phase duration (measured or otherwise ascertained) and the optimum partial phase duration (calculated) is the length of time which elapses or (at most) would have to elapse when the group of partial phases is carried out. In short, the partial phase duration is thus the length of time of all of the partial phases of the group combined.

The predefined amount by which the measured or ascertained partial phase duration may possibly deviate from the optimum partial phase duration can be chosen before the method according to the invention is carried out or the computer program product according to the invention is executed, wherein it is to be advised that the amount can also be chosen to be zero. By choosing a larger amount it can be determined from when the cycle time optimization according to the invention “starts”, i.e. if an optimum cycle time is less important in certain situations the predefined amount can be chosen to be larger than in a situation wherein the optimum cycle time is of greater importance.

According to the invention, items of information about the machine configuration of the molding system are used for the calculation of the optimum partial phase duration. For example, a maximum acceleration and a maximum velocity of a movable platen could be used to calculate the shortest possible time for achieving an opening stroke. Other examples would be locking movements for a clamping force mechanism or robot movements for removing molded parts, the shortest possible time for which can be calculated on the basis of the kinematic capabilities of the machine and the geometric situation (e.g. known travel).

The indication that the setting of the molding system is improvable with respect to the at least one partial phase or the at least one group of partial phases can be issued in a wide variety of ways. In the simplest case, a visual warning could appear on a screen of a machine control system of the molding system or an audible warning could be issued. At the same time, further items of information about which partial phases or groups of partial phases are affected and how large the potential saving of the cycle time is could be issued.

It is also conceivable that an improved setting of the molding system is directly suggested or is even automatically or semi-automatically performed (e.g. after confirmation by an operator).

It can be provided that all partial phases and/or all groups of partial phases are checked for an optimum partial phase duration according to the invention. In practice, however, this can take up a very large amount of resources, with the result that making a certain (pre-) selection may indeed also be preferred.

A computer-readable storage medium on which a computer program according to the invention is stored is also protected.

A molding system with a computer and a memory is furthermore protected, wherein a computer program product according to the invention is stored in the memory and the computer is set up to execute the computer program product according to the invention.

The molding system can in particular include one or more molding machine(s), one or more handling device(s) and/or one or more temperature control device(s).

By molding machines can be meant for example injection-molding machines, transfer-molding machines, molding presses and the like.

By handling devices can be meant for example handling robots of any desired configuration for removing molded parts and/or inserting semi-finished products, preforms or other inserts. Handling devices can alternatively or additionally include conveyor belts or the like.

By temperature control devices can be meant for example:
device for controlling the temperature of a mold, in particular injection mold
device for controlling the temperature of semi-finished products, preforms or other inserts, for example before they are inserted into a mold
device for controlling the temperature of molded parts.

The carrying out of the method according to the invention or the execution of the computer program product according to the invention can be initiated
actively by an operator of the molding system and/or
automatically in the case of a change of the setting of the molding system and/or
automatically periodically or continuously, preferably such that a continuous monitoring of an optimum cycle effectively results.

The method according to the invention or the computer program product according to the invention does not have to be used in a molding system that exists in reality, but can also be used in simulations of the production or partial processes for the production by means of the molding system.

It should be mentioned that the “optimum” partial phase duration is to be understood in the technical sense and not in the purely mathematical sense. An optimum partial phase duration is therefore based on known data or plausible assumptions regarding the performance capability of the molding system, without it being necessary to demonstrate in the scientific sense that shorter partial phase durations are entirely undoubtedly impossible.

With respect to the computer program product according to the invention, it should be mentioned that by receiving the data is also meant actively accessing the data (for example in a memory).

With respect to the computer program product according to the invention, it should furthermore be mentioned that the data received can include the partial phase duration, with the result that the determination of the data is realized by the receiving of the data and the extraction of the partial phase duration from the data.

Further preferred embodiments are defined in the dependent claims.

The partial phases can include at least one of the following: move mold cores in, closing of a clamping unit with rapid traverse, locking of the clamping unit, clamping force application, introduce injection unit, press injection unit on, open shutoff nozzle, injection movement of an injection element, holding pressure phase, withdrawal of the injection element, close shutoff nozzle, metering phase of a plasticizing unit, cooling phase of a molded part, clamping force reduction, unlocking of the clamping unit, opening of the clamping unit with rapid traverse, ejector movement, move mold cores out, stamping movement.

Within the framework of the invention, a large number of individual partial phases of the cycle can thus be examined. In principle, however, it is also conceivable for the cycle to include only a single partial phase, the partial phase duration of which is improved (for example in the case of certain molding presses).

Preferably, the partial phase duration can be ascertained as the duration of at least one set movement profile for at least one component of the molding system or measured as the actual duration of a movement of the at least one component of the molding system performed according to the at least one set movement profile.

It should be noted that different movements of a component of the molding system can fall within different partial phases of the cycle. For example, the opening of the clamping unit with rapid traverse and the closing of the clamping unit with rapid traverse are two different partial phases, which are, however, realized by the same components, namely as a rule of the movable platen driven by the rapid traverse.

These different movements can be stored as one or more movement profiles, wherein in the former case only the appropriate part of the movement profile should be used for ascertaining the partial phase duration according to the invention. It goes without saying that the movement profiles alluded to are in fact used to actuate a drive (in the above example for instance the rapid traverse drive) for the component (in the above example for instance the movable platen) and not necessarily for the component itself.

It should be noted that by the component of the molding system is also meant components of the various constituent parts of the molding system. In other words, for example the molding machine, the handling device or the temperature control device are taken to mean “constituent parts” of the molding system and the components of a molding system, the handling device or the temperature control device are also taken to mean components or the molding system.

In addition, it should be mentioned that partial phases of the cycle do not have to be provided only by movements. As already mentioned, cooling phases can likewise be partial phases within the meaning of the invention. It would also be conceivable for example to examine other actuations of modules such as heating elements or the application of force with active materials (piezoelectric, magnetostrictive or the like) for optimum partial phase durations according to the invention.

In this sense, it can be provided that the partial phase duration is ascertained as the duration of at least one set actuation profile for at least one component of the molding system or is measured as the actual duration of an action of the at least one component of the molding system performed according to the at least one set actuation profile.

The optimum partial phase duration can particularly preferably be calculated on the basis of maximum kinematic variables, in particular a maximum acceleration and/or a maximum velocity, of the at least one component and while retaining a conserved quantity of the at least one partial phase or at least one group of partial phases, wherein the conserved quantity is preferably a movement stroke or a displaced volume.

As already mentioned, for example the shortest possible time for closing a clamping unit of an injection-molding machine can be calculated relatively easily as optimum partial phase duration if the maximum acceleration, the maximum velocity and the travel for the closing movement are known.

The conserved quantity mentioned can ensure that the partial phase of the cycle is not changed unduly. For example, the cycle is naturally not to be “shortened” by the closing movement not being performed in full. In another example, the displaced volume—for example the injection volume in the case of an injection process—would naturally have to be complied with, because otherwise the mold would not be completely filled.

Of course, further boundary conditions can be used, for example for collision avoidance.

In particular, more complex methods for reducing the cycle time when several components are involved are known from the state of the art, for example a transfer head for removing a molded part from a mold that is still opening. These methods can be used within the framework of the invention, in particular if groups of partial phases are being checked for improved partial phase duration according to the invention.

It should be mentioned that by maximum accelerations or velocities are meant those values which are maximal in the technical sense, i.e. in accordance with which a durable and reliable operation of the molding system is possible. They could also be taken to mean nominal maximum accelerations or velocities.

It can be provided that the group of partial phases includes a first partial phase and a second partial phase, wherein the first partial phase and the second partial phase can be carried out at least partially overlapping in time, wherein it is calculated, taking the machine configuration into consideration, whether carrying out the first partial phase and the second partial phase at least partially overlapping in time or carrying out the first partial phase and the second partial phase sequentially results in a shorter optimum partial phase duration overall.

Time loss due to partial phases overlapping in time can for example result due to the fact that a hydraulic system can perform two movements only at reduced velocity, because one pump's delivery rate is not sufficient. A similar situation can arise if the total connected load for molding systems equipped with electrical drives is not sufficient to operate all drives at maximum velocity. Such aspects of the machine configuration of the molding system can therefore also be used for the checking of the cycle time according to the invention.

It has already been mentioned that, in addition to the indication that the setting of the molding system is improvable with respect to the at least one partial phase or the at least one group of partial phases, a suggestion for an improved setting of the molding system is issued.

The optimum partial phase duration can be calculated such that a physical and/or chemical molding process taking place in the molding system remains unchanged.

A mold-closing process on the one hand and an injection process on the other could be used as examples in the case of an injection-molding machine. In the vast majority of situations, for example, the speed at which the mold is closed will make no difference to the actual physical and/or chemical molding process. However, if the injection process were to be optimized according to the invention with respect to the partial phase duration (here: injection time), a molding process/filling process that is changed at least from a physical point of view would result, as the mold would be filled with the plasticized material at a higher speed. This may be desirable or undesirable depending on the situation.

Further advantages and details of the invention are revealed by the figures and the associated description of the figures. There are shown in:

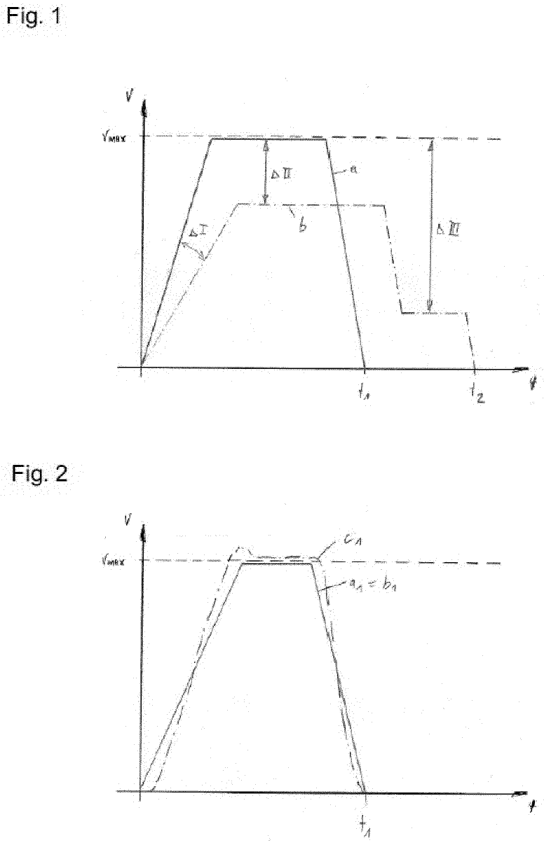

FIGS. 1 to 4 various graphs to illustrate several embodiment examples according to the invention,

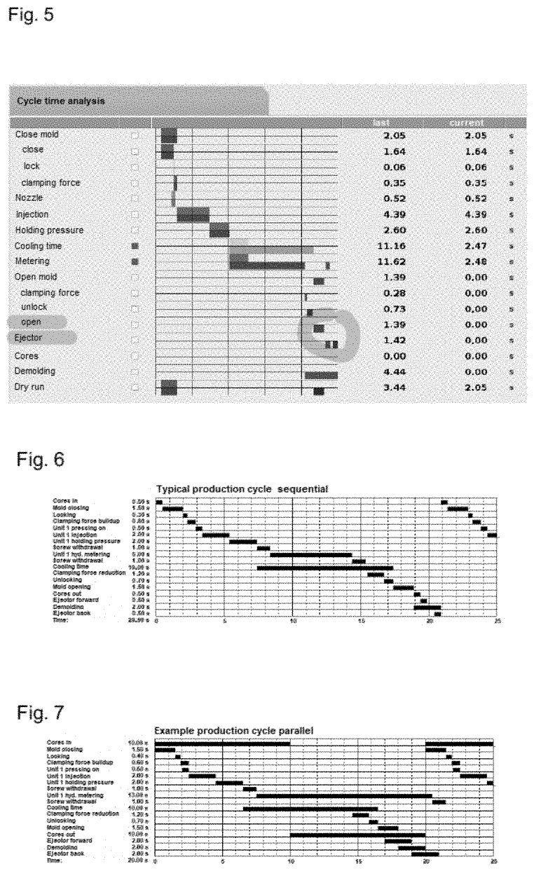

FIG. 5 a screenshot for the cycle time analysis in the case of a real molding machine,

FIGS. 6 to 8 various graphs to illustrate examples of movements that can potentially be performed in parallel and

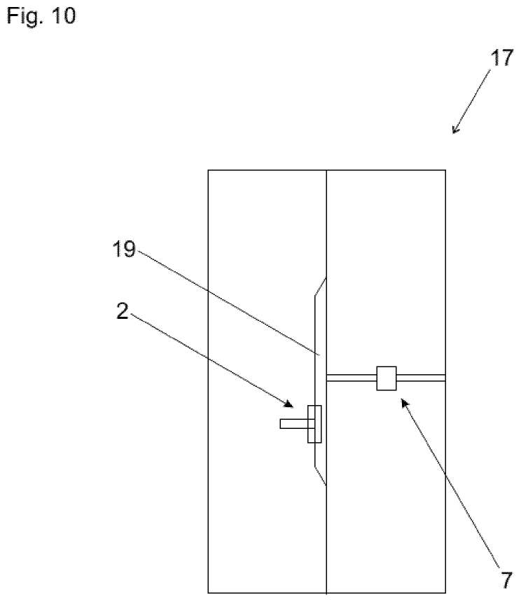

FIGS. 9 and 10 schematic representations of embodiments of a molding system according to the invention and a mold.

The achievement of the invention is, as mentioned, to provide the machine operator with a suitable tool which actively advises them of possibilities for cycle time savings, preferably makes suggestions for the optimization and alternatively or additionally even offers automatic optimization without changing the actual molding process (for example an injection-molding process) and thus the quality of the molded part.

The invention is explained below in the case of an injection-molding machine 10 with reference to several examples. In the case of other molding machines, the embodiment examples presented can be implemented in a similar manner.

In the case of each individual movement of an injection-molding machine 10 the maximum possible velocity determined by the system is usually known. The maximum possible acceleration and deceleration times can also be stored in the control system as maximum kinematic variables for each individual movement. Thus, for each movement, depending on the (movement) stroke set (by the operator), a minimum possible travel time can be calculated as optimum partial phase duration t1 (see FIG. 1) for the partial phase of the movement represented. If the time of this movement actually measured is now longer than that theoretically calculated, an indication is issued according to the invention.

Naturally, it is possible for the operator to deliberately set a slower velocity or a slower velocity profile. There can be various reasons for this:
the process does not allow a higher velocity
the operator is simply being cautious and underestimating the possible potential
the operator is totally unaware that a higher velocity is possible
after the first cautious initial settings, once good parts had been produced, carrying out further cycle optimizations was simply forgotten

FIG. 1 represents an example of a particular movement sequence for a particular travel, where the time is plotted on the x-axis and the velocity is plotted on the y-axis.

The two curves plotted represent the following velocity profiles as movement profiles:

curve a: theoretically maximum achievable velocity profile with minimum achievable time, i.e. optimum partial phase duration t1

curve b: velocity profile set by the customer with time theoretically achievable therewith, i.e. ascertained partial phase duration t2

The maximum possible profile “a” was not chosen by the operator. The question is whether it is a necessity in terms of process engineering. The theoretical total time saving potential would be t2 minus t1.

The following individual evaluations and optimization indications would be deducible from this setting example:
operator has set a lower initial acceleration—ΔI
the max. velocity has not been set—ΔII
an even lower velocity has been set at the end of the movement—ΔIII

It is quite usual and often necessary for a lower velocity to be chosen at the end of a increment, as the operator has chosen with curve b (ΔIII). This can serve to protect the mold 17 or to preserve an end stop.

Nevertheless, the question arises as to why vmax (ΔII) and/or the maximum acceleration (ΔI) has not been chosen at least in the first part of the movement. Naturally, the savings potential can also be calculated for each individual one of these steps.

Within the framework of the invention, the control system of the molding system 1 could issue three indications regarding non-optimum partial phase duration/cycle time and suggest eliminating the three named differences ΔI, ΔII, ΔIII in each case by setting the maximum kinematic variables. The operator could then confirm the first two suggestions, but retain the reduced velocity in the final portion of the movement profile (ΔIII).

FIG. 2 represents a simple movement sequence which utilizes the maximum possible specification at all points. In other words, the maximum possible profile a1 is utilized and is identical to the customer setting b1. The actual movement progression is represented with curve c1 and follows the target curve as far as possible.

In this situation there is therefore no possibility of a saving. However, even if operators utilize the maximum possible movement profile, the partial phase duration cannot be optimal.

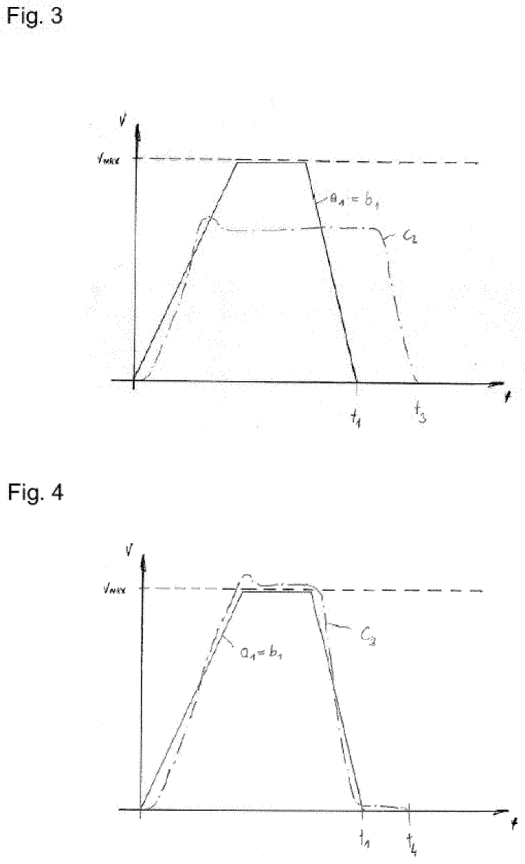

In FIG. 3 too, to be specific, the operator utilizes the maximum setting (a1=b1), but the actual velocity progression c2 does not follow the target curve. In this case, the maximum velocity is not achieved. Here, the operator can be advised that it may be that insufficient force is available, because, for example in the case of hydraulic drives, insufficient pressure has been chosen, the hydraulic lines to the consumer could be too small or the friction is too high, etc. Here too, it is again possible to specify the actual time loss (t3 minus t1).

It should be mentioned that partial phase duration t3 can be measured directly, for example. In many cases, such measured values will be present in a machine control system 13 of the molding system 1 anyway, with the result that the computer program product according to the invention only needs to access them in order to ascertain the partial phase duration t3.

A time loss that occurs very frequently in practice is represented at the end of the movement in FIG. 4. The desired end position is not directly achieved, with the result that a residual actuation is necessary for a certain time. This can have various causes, such as e.g. thermal expansion of the mold, increased friction at the end of the movement, tolerances that are chosen to be too narrow, minimum velocity too low. According to the invention, operators could be advised to check for these possible causes. The possible time saving potential here would be t4 minus t1.

The invention can also advantageously be used in the case of parallel movements.

Depending on the machine configuration in terms of drive engineering, but naturally also on the circumstances in terms of process engineering, there are different possibilities as to whether certain movements can be carried out in parallel or not.

Drive-engineering dependences of the machine configuration:
In the case of hydraulic molding machines, the possibility of parallel movements is dependent on the number and distribution of the pumps and also on the design with proportioning and/or throttling valves. Certain preconditions can also result from what control-engineering possibilities are provided by the software and the driving power.
In the case of electrical machines, each axle is usually fitted with its own drive and all movements could therefore theoretically be carried out in parallel. However, here too the total connected load for some movements may possibly be limiting and is optionally to be taken into consideration in the calculation of the optimum partial phase duration.
However, combinations of hydraulic, electrical or also pneumatic drives are also possible and can be correspondingly represented in the calculation of the optimum partial phase duration.

The computer program product according to the invention must in accordance with the invention naturally be capable of accessing these dependences and possibilities specifically for the molding system 1, in order to calculate the optimum partial phase duration.

As soon as these items of information are present, correlations that are relatively easy to process result. If, for example, the machine control system 13 is set up according to the machine configuration to operate the clamping unit 3 using a first pump system and the ejector 9 using a second pump system, then a parallel movement of the ejector 9 and the clamping unit 3 (e.g. opening movement) is possible in principle.

With the process-engineering dependences of the machine configuration, in the case of present-day molding systems 1, the operator is required above all and must be able to assess whether a parallel movement is possible and makes sense from a process-engineering point of view.

For example, the operator must be able to answer the question of whether or not a certain core puller 2 can already be moved out in parallel with the opening without damaging the mold 17 or the molded part. Naturally, it is in principle conceivable that this has already been stored in advance in electronically readable form in a database during the design of the mold 17. If the computer program product according to the invention has access to the database, it could itself assess whether the parallel movement is possible and makes sense without being reliant on an input by the operator for this.

A specific real-life example may be mentioned. FIG. 5 shows a screenshot of a cycle time analysis, as provided by an injection-molding machine 10 from the applicant. It can be seen in the graph from FIG. 5 that the ejector 9 is only activated after the partial phase “open” the mold (see highlighting).

The item of information as to whether a parallel movement of the ejector 9 and of the opening of the mold (i.e. opening of the clamping unit 3) is possible in principle is for example present in the machine control system 13. If that is the case, in this situation the operator could be given the indication: “ejector parallel with the opening possible”. The operator could even be redirected directly to the corresponding screen (with indications regarding where and what is to be changed in order to make use of the possibility of parallel movement) in order to set this parallel movement, if it is possible with the mold 17 used.

A list of possible partial phases of a cycle (mostly movements) of an injection-molding machine 10 from the applicant in a typical sequence is given below:
move cores 2 in
close rapid traverse 4
lock tie-bar nuts (locking devices 16)
clamping force buildup
move injection unit 6 forward (optionally several units)
build up contact pressure (optionally several units)
open shutoff nozzles 7 (optionally several shutoff nozzles 7)
injection (optionally several units)
holding pressure (optionally several units)
screw withdrawal before metering (optionally several units)
close shutoff nozzles 7 (optionally several shutoff nozzles 7)
metering (optionally several units)
screw withdrawal after metering (optionally several units)
cooling time (no machine movement—only time sequence)
clamping force reduction
unlocking
open rapid traverse 4
move cores 2 out
ejector 9 forward
ejector 9 back

There are a large number of further movements in the case of special designs, such as e.g. stamping, shutoff nozzles, charge battery, further additional units, etc.

A typical production cycle with the most common movements when the partial phases in one cycle run sequentially is represented by way of example in the following graph from FIG. 6. The partial phases “cooling time” and “demolding” are not movements, but merely process-related waiting times.

The graph from FIG. 7 shows a similar cycle, but with representation of a large number of parallel movements possible in terms of process engineering, such as example:
an actuation of the core pullers 2 may be desired over the entire cycle in parallel with all other movements
pressing on in parallel with the clamping force buildup
metering in parallel with the opening and closing of the clamping unit 3, movements of the ejector 9 and movements of cores 2

Naturally, handling devices, such as removal devices, robot 11 or other peripheral devices can also be included in the consideration, in particular when these devices are attached to the same control system as the injection-molding machine 10 (as is the case e.g. in an injection-molding machine 10 in combination with a removal device/handling devices from the applicant) and thus not only are release signals of conventional interfaces available, but all production or sequence data such as e.g. travels of the robot axes, time signals, sequences.

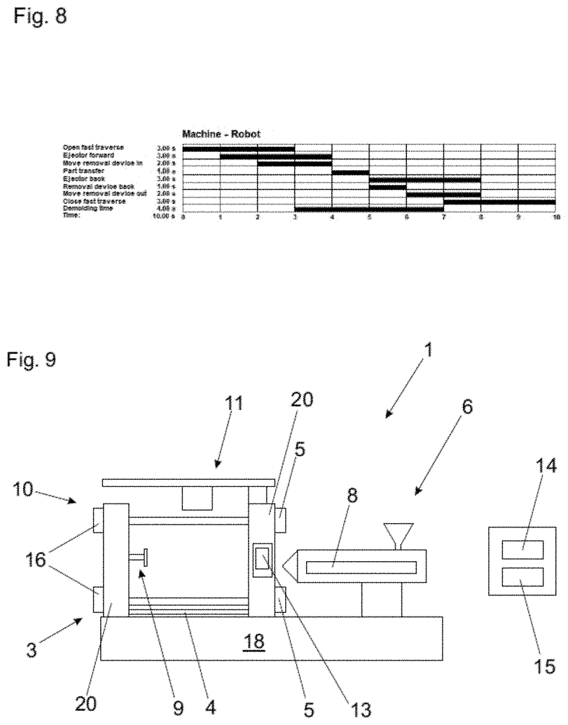

An example of parallel movement sequences in the molding system 1 during the removal of molded parts by means of a removal device is represented in FIG. 8.

It is likewise conceivable to incorporate the influence of e.g. temperature control devices. The machine control system could evaluate whether the full cooling power of a temperature control device used is utilized. Should that not be the case, the indication that the cooling time can possibly be shortened by increasing the cooling power can be provided.

Naturally, the combination of faster or slower movement and parallel movement can also be advised. There are different configurations here:
parallel movements which do not influence one another (all movements possible at 100% velocity)
movements which proceed more slowly due to parallel operation (because for example the available hydraulic pump volume is split or the driving power is simply not sufficient to carry out several movements at full power at the same time).

If the velocities influence one another in parallel operation (i.e. would be slower in parallel operation), the machine control system 13 can also suggest the cycle-time-optimized variant here. In other words, it could indeed be the case that a parallel movement is no longer necessary at all due to faster movement and therefore even more cycle time is saved. The reverse case is naturally also possible, namely that although an individual movement cannot be made at full velocity due to a parallel movement, in total more time is saved because the cycle sequence need not wait for this movement.

A specific example in this respect: an injection-molding machine 10 has the drive-engineering possibility of metering in parallel with the opening of the clamping unit 3, thus of plasticizing material for the next cycle in the plasticizing unit 6. However, in parallel operation both velocities are reduced to 50% of the respective maximum velocities.

However, the operator has not chosen the parallel function, but instead used both velocities at 100%. Nevertheless, the metering process in this case lasts 2 seconds longer than the cooling time. Thus, the opening process cannot, as is usual, start at the end of the cooling time, but only 2 seconds later at the end of metering.

Here, the machine control system 13 can now precisely calculate what it would mean to select the parallel function. Although the opening movement would only be made at 50% of the velocity, it can be worked out with reference to the known opening stroke whether the movement would become more or less than 2 seconds slower. If it is less, then on the whole selecting the parallel movement is the better option. On the other hand, if the opening movement is lengthened by more than 2 seconds, then on the whole the sequential 100% setting is the better alternative.

The following possibilities exist for the activation of the optimization program according to the invention:
active one-time start of the optimization by the machine operator, for example during the production
automatic continuous optimization in the production cycle
automatic optimization after every parameter change
virtual optimization on a simulator with possible programed process parameters

The cycle time plays an increasingly important part in the production of injection-molded parts in particular and molded parts in general, and very often higher investment costs are accepted in order to realize faster or parallel movements.

However, it is very frequently shown in practice that machine operators often do not utilize the available potential. From experience the inventor knows that in the case of almost every injection-molding machine there is a cycle time optimization potential of from 5% to 10%, for example because the machine operator has insufficient knowledge of the machine's capabilities or does not know how to make use of them.

An analysis and help tool according to the invention which specifically informs the operator how much potential is theoretically available and where and shows them how they could make use of it will make molding systems much more efficient in practice.

FIG. 9 schematically shows a molding system 1 with a molding machine, in this case an injection-molding machine 10.

In this embodiment example, the molding system 1 additionally includes a robot 11 as a device for removing molded parts produced by the injection-molding machine 10.

The injection-molding machine 10 includes a clamping unit 3 and a combined plasticizing and injection unit 6.

The plasticizing unit 6 could also be designed separate from the injection unit.

In the present embodiment example, the clamping unit 3 and the plasticizing and injection unit 6 are arranged on a common machine frame 18.

In this case, the clamping unit 3 is a horizontal 2-plate clamping unit, wherein the invention can naturally equally be used with 3-plate clamping units or vertically aligned clamping units 3.

The clamping unit 3 comprises:
platens 20 movable relative to one another
a rapid traverse 4 for rapidly moving the platens 20 (in this embodiment example hydraulically, could also be operated electrically)
locking devices 16
hydraulic pressure pads 5 for building up the clamping force (electrical clamping force mechanisms are also usual)
ejector 9

The plasticizing and injection unit 6 includes an injection element 8, in this embodiment example a plasticizing screw.

Furthermore, a central machine control system 13 is provided, which is connected by means of signaling to all actuators and actuatable components of the molding system 1 (not drawn in for reasons of clarity).

The computer program product according to the invention can be executed on a unit with a memory 15, on which the computer program product is stored, and a computer 14, which is set up to execute the computer program product.

The computer 14 and/or the memory 15 can be implemented by the machine control system 13.

The computer 14 and/or the memory 15 can alternatively or additionally be arranged remote from the molding system 1 (e.g. as a cloud server) and be connected to the machine control system 13 of the molding system 1 with a remote data transmission connection.

A mold 17, which produces a mold cavity 19 in the closed state, can be clamped on the platens 20 of the clamping unit 3 (see a schematic embodiment example in FIG. 10).

The mold 17 can have one or more shutoff nozzles 7 and one or more cores 2 (for example for molding undercuts).

### LIST OF REFERENCE NUMBERS

molding system 1
mold core 2
clamping unit 3
rapid traverse 4
pressure pad 5
injection unit, plasticizing unit 6
shutoff nozzle 7
injection element 8
ejector 9
injection-molding machine 10
robot 11
machine control system 13
computer 14
memory 15
locking devices 16
mold 17
machine frame 18
mold cavity 19
platens 20

1. A method for improving a cycle time of a molding system operating in cycles, wherein
the molding system is set up to produce molded parts in cycles, wherein the cycles include partial phases,
for at least one partial phase or at least one group of partial phases a partial phase duration is measured or ascertained with reference to settings of the molding system,
an optimum partial phase duration is calculated for the at least one partial phase or the at least one group of partial phases on the basis of a machine configuration,
if the measured or ascertained partial phase duration deviates from the optimum partial phase duration by more than a predefined amount, an indication that the setting of the molding system is improvable with respect to the at least one partial phase or the at least one group of partial phases is issued.

2. The method according to claim 1, wherein the partial phases include at least one of the following: move mold cores in, closing of a clamping unit with rapid traverse, locking of the clamping unit, clamping force application, introduce injection unit, press injection unit on, open shutoff nozzle, injection movement of an injection element, holding pressure phase, withdrawal of the injection element, close shutoff nozzle, metering phase of a plasticizing unit, cooling phase of a molded part, clamping force reduction, unlocking of the clamping unit, opening of the clamping unit with rapid traverse, ejector movement, move mold cores out, out, stamping movement.

3. The method according to claim 1, wherein the partial phase duration is ascertained as the duration of at least one set movement profile for at least one component of the molding system or is measured as the actual duration of a movement of the at least one component of the molding system performed according to the at least one set movement profile.

4. The method according to claim 3, wherein the optimum partial phase duration is calculated on the basis of maximum kinematic variables, in particular a maximum acceleration and/or a maximum velocity, of the at least one component and while retaining a conserved quantity of the at least one partial phase or at least one group of partial phases, wherein the conserved quantity is preferably a movement stroke or a displaced volume.

5. The method according to claim 1, wherein the group of partial phases includes a first partial phase and a second partial phase, wherein the first partial phase and the second partial phase can be carried out at least partially overlapping in time, wherein it is calculated, taking the machine configuration into consideration, whether carrying out the first partial phase and the second partial phase at least partially overlapping in time or carrying out the first partial phase and the second partial phase sequentially results in a shorter optimum partial phase duration overall.

6. The method according to claim 1, wherein, in addition to the indication that the setting of the molding system is improvable with respect to the at least one partial phase or the at least one group of partial phases, a suggestion for an improved setting of the molding system is issued.

7. The method according to claim 1, wherein the optimum partial phase duration is calculated such that a physical and/or chemical molding process taking place in the molding system remains unchanged.

8. A computer program product for improving a cycle time of a molding system operating in cycles, in particular for carrying out a method according to claim 1, with instructions which prompt a computer executing them
to receive data in the form of measured values and/or setting data and to determine a partial phase duration for at least one partial phase of the cycles or at least one group of partial phases of the cycles with reference to the measured values or setting data,
to calculate an optimum partial phase duration for the at least one partial phase or the at least one group of partial phases on the basis of a machine configuration and
to check whether the measured or ascertained partial phase duration deviates from the optimum partial phase duration by more than a predefined amount and, if this is the case, to issue an indication that the setting of the molding system is improvable with respect to the at least one partial phase or the at least one group of partial phases.

9. A computer-readable storage medium, on which the computer program product according to claim 8 is stored.

10. A system with a computer and a memory, wherein the computer program product according to claim 8 is stored in the memory and the computer is set up to execute the computer program product according to claim 8.
